(19) United States
(12) Patent Application Publication
(10) Pub. No.: US 2025/0344714 A1
(43) Pub. Date: Nov. 13, 2025

(54) BLOOM-RETARDING ADDITIVE

(71) Applicant: AAK AB (PUBL), Malmo (SE)

(72) Inventors: Bjarne JUUL, Malmo (SE); Jeppe Lindegaard HJORTH, Malmo (SE)

(21) Appl. No.: 18/869,415

(22) PCT Filed: May 31, 2023
(86) PCT No.: PCT/SE2023/050539

§ 371 Date: Nov. 26, 2024

(30) Foreign Application Priority Data
May 31, 2022 (SE) 2230171-7

(51) Int. Cl. A23G 1/36; A23D 9/04

(52) U.S. Cl. CPC A23G 1/36; A23D 9/04

(57) ABSTRACT

The present invention relates to the field of chocolate and chocolate-like products. More specifically, the present invention relates to additives for chocolate and chocolate-like products, and in particular an additive that is derived from cocoa-butter. The additive enhances the shelf-life of chocolate and chocolate-like products by delaying the onset of bloom.

### FIELD

The present invention relates to the field of chocolate and chocolate-like products. More specifically, the present invention relates to additives for chocolate and chocolate-like products, and in particular an additive that is derived from cocoa-butter. The additive enhances the shelf-life of chocolate and chocolate-like products by delaying the onset of bloom.

### BACKGROUND

Across the world, chocolate is regarded as being one of the finest types of confectionary, and various types and shapes of chocolate have been developed over the years. Innovation within the field of chocolate has largely focused on sensory aspects, such as the taste and mouthfeel of chocolate. The visual appearance of a chocolate is, however, also important for a consumer's overall perception of quality.

One of the key issues relating to the visual appearance of chocolate is the formation of bloom. Bloom is an easily recognisable phenomenon that occurs in chocolate thereby rendering its surface dull and slightly white. Bloom can occur at any time, but typically takes place after weeks or months of storage.

One of the causes of bloom is changes in the crystal form of the fats, such as cocoa butter, in a chocolate product. Cocoa butter can exist in a number of different polymorphic crystal forms. The most desirable form of cocoa butter is Form V as this imparts a desirable glossy appearance and appealing snap to chocolate. In order to obtain a chocolate product in which cocoa butter in present predominantly in Form V, the chocolate ingredients are mixed and then tempered. During the tempering process, chocolate is heated and slowly cooled to encourage the formation of Form V crystals of cocoa butter.

Unfortunately, Form VI rather than Form V is the most stable polymorphic form of cocoa butter. Thus, over time and particularly when particularly when stored somewhere warm or fluctuating in temperature, Form V can undergo polymorphic transition into Form VI. It is this change in crystal form that can lead to the appearance of bloom on the surface of chocolate.

Poor tempering of chocolate, in which Form IV is formed rather than Form V, can accelerate the onset of bloom. However, even well-tempered chocolate will bloom when stored for long periods and/or in unfavourable conditions. As such, various methods for avoiding the formation of bloom in chocolate have been proposed. One of these methods is the use of bloom-retarding components.

Bloom-retarding components that have been used in the past include high-melting milk fat fractions, sorbitan tristearate, and triglyceride compositions which are used as a substitute for at least some of the cocoa butter in chocolate. Triglyceride compositions may be obtained by chemical interesterification of vegetable fats in the presence of particular catalysts.

An alternative triglyceride composition is disclosed in WO 2014/071955. This document discloses a process for preparing a bloom-retarding component for chocolate and chocolate-like products. The process comprises deodorising a triglyceride composition comprising at least 40% by weight of monounsaturated symmetric triglycerides for at least 60 minutes at a temperature of at least 220° C. Although the bloom-retarding component that is prepared in WO 2014/071955 is shown to be very effective at enhancing the visually-acceptable shelf-life of chocolate and chocolate-like products, it unfortunately impacts the viscosity—and therefore handling—of the chocolate during processing. Thus, the composition of the chocolate and/or processing conditions may have to be modified to take account of the viscosifying effect of the bloom-retarding additive.

Another alternative triglyceride composition is disclosed in WO 2020/236076. This document also discloses a process for preparing a bloom-retarding component for chocolate and chocolate-like products. The process comprises deodorising a triglyceride composition comprising 40 to 95% by weight of monounsaturated symmetric triglycerides for at least 60 minutes at a temperature of at least 220° C.

Although the bloom-retarding components that are prepared in WO 2014/071955 and WO 2020/236076 are shown to be very effective at enhancing the visually-acceptable shelf-life of chocolate and chocolate-like products, it unfortunately impacts the viscosity—and therefore handling—of the chocolate during processing. Thus, the composition of the chocolate and/or processing conditions may have to be modified to take account of the viscosifying effect of the bloom-retarding additive.

Accordingly, there remains a need for bloom-retarding additives for chocolate and chocolate-like products. In particular, there remains a need for additives which increase the time period over which the product remains visually appealing to consumers, but which does not affect the processability of the product.

### SUMMARY

It has surprisingly been found that a highly effective bloom-retarding additive, which does not significantly affect the viscosity of a chocolate or chocolate-product in which it is used, may be prepared by a method in which a mixture of cocoa butter and free fatty acids, at least some of which are unsaturated, is maintained at an elevated temperature for a significant period of time. Lower viscosity is beneficial in many areas of chocolate production since it makes a chocolate or chocolate-like product easier to handle in production, easier to distribute in moulds and easier to use as coating. Without wishing to be bound by theory, it is believed that a ratio by weight of SatSatO to Sat₃≥1.5, preferably >1.6, and more preferably >1.7, at least in part, responsible for the beneficial properties of the additive that is produced in the reaction.

Accordingly, in one aspect, the present invention provides a bloom-retarding additive for use in a chocolate or a chocolate-like product, wherein the additive is a modified cocoa butter which comprises:
SatOSat in an amount of at least 55% by weight,
SatSatO in an amount of at least 1.5% by weight, and
a ratio by weight of SatSatO to Sat₃≥1.5, preferably >1.6, and more preferably >1.7.

Also provided is a method for preparing a bloom-retarding additive for a chocolate or chocolate-like product, said method comprising:
a) providing a reaction mixture which comprises cocoa butter and free fatty acids, wherein at least some of the free fatty acids are unsaturated; and
b) forming the additive by heating the reaction mixture to a temperature of at least 190° C. and maintaining the temperature for a period of at least 4 hours

In a further aspect, an ingredient for a chocolate an ingredient for a chocolate or chocolate-like product is provided which comprises a bloom-retarding additive of the present invention and cocoa butter and/or a cocoa butter equivalent, as well as a method of preparing an ingredient for a chocolate or chocolate-like product which comprises blending the bloom-retarding additive of the present invention with cocoa butter and/or a cocoa butter equivalent.

Also provided is a chocolate or chocolate-like product which comprises a bloom-retarding additive or an ingredient for a chocolate or chocolate-like product of the present invention and one or more further edible ingredients, as well as a method of preparing a chocolate or chocolate-like product which comprises blending a bloom-retarding additive or an ingredient for a chocolate or chocolate-like product of the present invention with one or more further edible ingredients.

Bloom-retarding additives, ingredients for a chocolate or chocolate product, and chocolate or chocolate-like products, which are obtainable by a method of the present invention are further provided.

In another aspect, the invention provides for various uses of a bloom-retarding additive or ingredient for a chocolate or chocolate-like product of the present invention. For instance, use of the bloom-retarding additive or the ingredient in a chocolate or chocolate-like product is provided. Also provided is the use of the bloom-retarding additive or the ingredient as a bloom-retarding component in a chocolate or chocolate-like product. Further provided is the use of the bloom-retarding additive or the ingredient for retarding bloom while maintaining the processability of a chocolate or chocolate-like product. Use of the bloom-retarding additive in cocoa butter or a cocoa butter equivalent is also provided. Finally provided is the use of the bloom-retarding additive for enhancing the bloom-retarding properties of cocoa butter or a cocoa butter equivalent.

The aspects of the inventions are described in further detail below.

### DETAILED DESCRIPTION

### Definitions

The following definitions apply throughout this specification, and for the interpretation of the claims.

“Sat” is used to denote any saturated fatty acid, and “U” is used to denote any unsaturated fatty acid. “P” is used to denote palmityl, “O” is used to denote oleyl, and “S” is used to denote stearyl.

“X₃” is used to denote the sum of any triglyceride comprising three of the fatty acid “X”. “X₂Y” is used to denote the sum of any triglyceride comprising two of the fatty acid “X” and one of the fatty acid Y in any stereoisomeric form. The amounts, in % by weight, of non-stereospecific triglycerides, such as X₃ and X₂Y, that are present in a triglyceride composition may be determined using the method AOCS Ce 5b-89 (revised 2017).

“SatSatO” is used to denote the sum of all isomers of asymmetric monounsaturated triglycerides (i.e. SatSatO, OSatSat) with the unsaturated fatty acid, i.e. oleic acid, in the 1- or 3-position. Similarly, “SatOSat” is used to denote the sum of all isomers of symmetric monounsaturated triglycerides with the unsaturated fatty acid, i.e. oleic acid, in the 2-position, and saturated fatty acids in the 1- and 3-position.

In the embodiments where one may like to determine the individual positional isomers, such as SatOSat or SatSatO, were determined by High Performance Liquid Chromatography (HPLC) in combination with an Evaporative Light Scattering Detector (ELSD). The sample preparation consists of an epoxidation of the double bonds of unsaturated fatty acids. This method is known, and suitable methods are available at commercial laboratories, such as Reading Scientific Services Ltd. and Mylnefield Lipid Analysis.

A “chocolate product” contains vegetable fats other than cocoa butter in a total amount of up to 5% by weight of the product. A “chocolate-like product” contains vegetable fats other than cocoa butter in a total amount of more than 5% by weight of the product.

“Cocoa butter” is the fat that is released from roasted cocoa beans on pressing. “Raw cocoa butter” is cocoa butter that has not been refined, i.e. subjected to harsh processing conditions such as high temperatures or reactive or catalytic environments, which may significantly modify its composition.

“Cocoa butter equivalents” are well-known in the art as edible fats, typically made up of one of more vegetable fats, having a composition and properties that are similar to cocoa butter, and that are compatible with cocoa butter and that have no significant effect on the behaviour of a chocolate in which they are used.

A “bloom-retarding” additive, when used in a chocolate or chocolate-like product, prevents, reduces or delays the formation of fat bloom on the product as compared to a product containing the cocoa butter from which the bloom retarding additive is derived, i.e. the cocoa butter before it is subjected to the method of the present invention.

### Bloom-Retarding Additive

The present invention provides a bloom-retarding additive which may be used in a chocolate or chocolate-like product. The bloom-retarding additive is a modified cocoa butter. In other words, the additive is a triglyceride composition derived from cocoa butter, such as from a cocoa butter as described below.

The bloom-retarding additive comprises:
SatOSat in an amount of at least 55% by weight, for example 55-80% by weight, or 60-75% by weight,
SatSatO in an amount of at least 1.5% by weight, for example 4-8 by weight, and a ratio by weight of SatSatO/Sat₃≥1.5, preferably >1.6, and more preferably >1.7.

The SatOSat content of the present invention is at least 55% by weight, for example 55-80% by weight, or 60-75% by weight. Increasing amount of SatOSat will make the chocolate or chocolate-like product harder. SatOSat content a typical cocoa butter is typical about 80% by weight.

The additive may comprise triunsaturated triglycerides (U₃) in an amount by weight which is higher than that of the cocoa butter from which it is derived, for instance higher by at least 0.2%, for example at least 0.5% or at least 0.8%. It will be appreciated that “higher” in this context—in relation to U₃ but also other components of the additive composition—means the change in % content by weight, and not a % uplift on the original weight value. For instance, if the bloom-retarding additive contains U₃ in an amount of 1.5% by weight and the cocoa butter from which the additive is derived contains U₃ in an amount of 0.5% by weight, then the additive contains U₃ in an amount by weight which is higher by 1% than that of the cocoa butter. The additive may comprise U₃ in an amount of at least 1.5%, for example at least 2%, or at least 2.5% by weight.

The additive may comprise diunsaturated triglycerides (SatU₂) in an amount by weight as low as possible, in order not to deviate too much from the SatU₂ content in cocoa butter, typical below 25% by weight.

The additive may comprise monounsaturated triglycerides (Sat₂U) in an amount by weight as heigh as possible, in order not to deviate too much from the Sat₂U content in cocoa butter, typical 70-85% by weight.

The additive may comprise saturated triglycerides (Sat₃) in an amount by weight which is higher than that of cocoa butter, for example in an amount of at least 2% by weight, or at least 2.5% by weight, or at least 3.0% by weight.

An advantage of the present invention is that the content of asymmetric monounsaturated fats (SatSatO) in the additive is relatively high thereby, at least in part, offsetting the detrimental properties of Sat₃. The additive may comprise SatSatO in an amount by weight which is higher than that of the cocoa butter from which it is derived, for instance in an amount of at least 3% by weight, preferably at least 5% by weight, more preferably at least 7% by weight.

The amounts of Sat₃ and SatSatO in the bloom-retarding additives of the present invention mean that the additive contains a desirable ratio by weight of SatSatO, i.e. asymmetric monounsaturated fats, to Sat₃ (i.e. SatSatO/Sat₃). The ratio by weight in the additive of the ratio SatSatO to Sat₃ may be significantly higher than that of cocoa butter, for example said ratio is ≥1.5, preferably >1.6, and more preferably >1.7.

### Method for Preparing a Bloom-Retarding Additive

The present invention also provides a method for preparing a bloom-retarding additive for a chocolate or chocolate-like product, such as a bloom-retarding additive of the present invention.

In step a) of the method, a reaction mixture is provided which comprises cocoa butter and free fatty acids. The reaction mixture may be provided by adding free fatty acids to cocoa butter to form the reaction mixture.

The cocoa butter that is used in step a) is not particularly limited. However, it is generally preferred that the cocoa butter is a raw cocoa butter.

The majority of the monounsaturated triglycerides in cocoa butter are symmetric in nature. Thus, the cocoa butter used in step a) may comprise SatOSat in an amount of at least 60%, preferably at least 65%, and more preferably at least 70% by weight. These cocoa butters are believed to be preferred for preparing additives having a ratio by weight of SatSatO/Sat₃≥1.5, preferably >1.6, and more preferably >1.7, particularly where free fatty acids are used in step a) in an amount of at least 5% by combined weight of free fatty acids and cocoa butter.

Particularly important symmetric triglycerides are POP, SOS and POS. In some embodiments, the cocoa butter used in step a) may comprises POP, SOS and POS in a combined about of at least 60%, preferably at least 65%, and more preferably at least 70% by weight.

Compositions which comprise substantial amounts of symmetric monounsaturated triglycerides like POP, SOS and POS, such as cocoa butter, are not normally subjected to high temperatures for a long time (e.g. deodorised), because even minor changes in the triglyceride composition can compromise the properties, such as melting profile, of a chocolate or chocolate-like product in which the composition is used. It is therefore surprising that a cocoa butter may be treated using a method of the present invention, yet yields an additive which prevents bloom and at the same time maintains processability of a chocolate or chocolate-like product in which the additive is used.

Cocoa butter will typically contain a relatively low amount of asymmetric monounsaturated triglycerides. For instance, the cocoa butter used in step a) may comprise SatSatO in an amount of up to 1%, preferably up to 0.75%, and more preferably up to 0.5% by weight.

The amount of saturated triglycerides (Sat₃) in cocoa butter is also relatively low typically being up to 3%, preferably up to 2.5%, and more preferably up to 2% by weight. This relatively low amount of Sat₃ has previously been believed to help tempered chocolate maintain its viscosity, and therefore processability, over time. However, the ratio SatSatO/Sat₃ in the cocoa butter is typical below 0.5.

The free fatty acids that are added to the cocoa butter in step a) of the method may be selected from oleic acid, stearic acid, palmitic acid and combinations thereof. These fatty acids are preferred because they correspond to those typically found in the triglycerides in cocoa butter. Though less preferred, other fatty acids may also be used in the method such as C8 to C22 fatty acids.

The free fatty acids that are added to the cocoa butter comprise unsaturated fatty acids. For instance, the free fatty acids may comprise unsaturated fatty acids in an amount of at least 10%, preferably at least 20%, and more preferably at least 30% by weight of the fatty acids. Where a mixture of saturated and unsaturated fatty acids is used, the free fatty acids preferably comprise saturated fatty acids in an amount of at least 10%, preferably at least 20%, and more preferably at least 30% by weight.

The free fatty acids may be added to the cocoa butter in an amount of at least 1%, preferably at least 5%, and more preferably at least 10% by combined weight of free fatty acids and cocoa butter. The free fatty acids may be added to the cocoa butter in an amount of up to 35%, preferably up to 30%, and more preferably up to 25% by combined weight of free fatty acids and cocoa butter. Thus, the free fatty acids may be added to the cocoa butter in an amount of from 1 to 35%, preferably from 5 to 30%, and more preferably from 10 to 25% by combined weight of free fatty acids and cocoa butter.

One of the advantages of the present invention is that the method may be carried out successfully without requiring a catalyst and/or a solvent. Indeed, in some embodiments, the reaction mixture contains the free fatty acids and cocoa butter in an amount of greater than 90% by weight, preferably greater than 95% by weight, and more preferably greater than 99% by weight. Particularly preferred is a reaction mixture which consists of the free fatty acids and cocoa butter.

Once the reaction mixture containing free fatty acids and cocoa butter has been prepared, the additive may be formed in step b) of the method.

In step b), the reaction mixture is heated to a temperature of at least 190° C., preferably at least 200° C., and more preferably at least 210° C. The reaction mixture may be heated to a temperature of up to 240° C., preferably up to 235° C., and more preferably up to 230° C. Thus, the reaction mixture may be heated to a temperature of from 190 to 240° C., preferably from 200 to 235° C., and more preferably from 210 to 230° C. Particularly preferred is a temperature of from 210 to 220° C.

This temperature is maintained for a period of at least 4 hours. The temperature may be maintained for a period of at least 6 hours, preferably at least 8 hours, and more preferably at least 10 hours. The temperature may be maintained for a period of up to 20 hours, preferably up to 18 hours, and more preferably up to 16 hours. Thus, the temperature may be maintained for a period of from 6 to 20 hours, preferably from 8 to 18 hours, and more preferably from 10 to 16 hours.

The step of forming the additive is preferably carried out under vacuum to accelerate evaporation of water and thereby shift the reaction towards triglycerides instead of diglycerides. The skilled person will know the pressure to apply for generation the vacuum.

The skilled person will, of course, appreciate that the progress of the reaction is influenced by the reaction conditions and composition of the reaction mixture. For instance, the reaction will generally progress more quickly when higher temperatures are used.

Step b) will typically be carried out in a sealed vessel, i.e. a vessel from which no material is lost and to which no material is added during the reaction, as this prevents free fatty acids from leaving the reaction mixture. However, other methods for retaining the free fatty acids in the reaction mixture may also be used, such as by using a reflux condenser which returns vapours to the reaction mixture.

Once the reaction in step b) is complete, the reaction mixture will contain the bloom-retarding additive and free fatty acids. The free fatty acids are preferably separated from the additive in step c), e.g. by distillation or any other suitable method.

Preferably, the reaction mixture that is present at the end of step b) is used directly in the subsequent separation step. In other words, the reaction mixture at the end of step b) is not subjected to further processing that might change its composition, such as the addition and/or withdrawal of components from the reaction mixture. The reaction mixture may optionally be filtered, and the free fatty acids are separated from the additive by distillation (stripping), typical to an amount of <2% by weight free fatty acids in the mixture, and finally the mixture is deodorized. The skilled person will know how to perform the distillation and deodorization step.

Where separation step c) is carried out by distillation, distillation of the free fatty acids may be carried out at a temperature of at least 180° C., preferably at least 200° C., and more preferably at least 220° C. Distillation may be carried out at a temperature of up to 270° C., preferably up to 260° C., and more preferably up to 250° C. Thus, distillation may be carried out at a temperature of from 180 to 270° C., preferably from 200 to 260° C., and more preferably from 220 to 250° C.

Distillation may be carried out for a period of a few minutes to a couple of hours, depending on the composition of the additive, the pressure, and the temperature.

Distillation may be carried out under vacuum. Where a vacuum is not used, the reaction is preferably carried out under an inert atmosphere, such as a nitrogen or argon atmosphere. Where a vacuum is used, the reaction may also be carried out under an inert atmosphere, such as those described previously.

The skilled person will know the duration of the distillation by the circumstances.

Suitable distillation conditions include a temperature of 240° C. and reduced pressure, but other conditions may be used. It is generally preferred that the distillation conditions are applied only until the free fatty acids have been removed to avoid any significant further changes to the composition of the bloom-retarding additive.

It will be appreciated that, unlike reaction step b), separation step c) will not typically be carried out in a sealed vessel from the vessel but rather a vessel with an outlet through which the fatty acids may be withdrawn.

In some embodiments, the bloom-retarding additive may be further processed before it is used in a chocolate or chocolate-like product. For instance, the additive may be fractionated using, for example, dry or solvent fractionation processes.

However, in preferred embodiments, the bloom-retarding additive that is prepared in step b) is, aside from the preferred separation of the free fatty acids in step c), used directly in a chocolate or chocolate-like product. Thus, an advantage of the present invention is that the additive does not need to be subjected to further processing steps, such as fractionation or the like. This is unlike prior art methods in which e.g. fractionation steps are often required to reduce the contents of certain components such as saturated triglycerides (Sat₃).

### Ingredient for a Chocolate or Chocolate-Like Product

The bloom-retarding additive of the present invention may be used in a number of different ways. For instance, the additive may be used in cocoa butter or a cocoa butter equivalent to give an ingredient for a chocolate or chocolate-like product.

An ingredient for a chocolate or chocolate-like product of the present invention comprises a bloom-retarding additive of the present invention and cocoa butter or a cocoa butter equivalent. Though less preferred, a combination of cocoa butter and a cocoa butter equivalent may also be used in the ingredient.

Preferably, the ingredient comprises cocoa butter. Any cocoa butter, i.e. any cocoa butter that is not processed in accordance with the method of the present invention, may be used with the bloom-retarding additive. For instance, the cocoa butter may be one that is processed using prior art methods, for instance it may be deodorised, or the cocoa butter may be a raw cocoa butter.

When the additive is used with a cocoa butter equivalent, suitable cocoa butter equivalents for inclusion in the ingredient for a chocolate or chocolate-like product include shea oil (Butyrospermum parkii), palm oil (Elaeis guineensis, Elaeis olifera), illipe oil (Shorea spp.), mango oil (Mangifera indica), sal oil (Shorea robusta), kokum oil (Garcinia indica). It will be appreciated that a combination of cocoa butter equivalents may also be used.

The ingredient for a chocolate or chocolate-like product may comprise the bloom-retarding additive in an amount of at least 20%, preferably at least 35%, and more preferably at least 50% by weight of the ingredient. The ingredient for a chocolate or chocolate-like product may comprise the bloom-retarding additive in an amount of up to 99%, preferably up to 97%, and more preferably up to 95% by weight of the ingredient. Thus, ingredient for a chocolate or chocolate-like product may comprise the bloom-retarding additive in an amount of from 20 to 99%, preferably 35 to 97%, and more preferably 50 to 95% by weight of the ingredient. It will be appreciated that, where more than one bloom-retarding additive of the present invention is used, these amounts refer to the total amount of bloom-retarding additive in the ingredient. The ingredient for a chocolate or chocolate-like product may comprise the cocoa butter or cocoa butter equivalent in an amount of at least 40%, preferably at least 50%, and more preferably at least 60% by weight of the ingredient. It will be appreciated that, where a combination of cocoa butters, or a combination of cocoa butter equivalents, or a combination of cocoa butter and cocoa butter equivalent is used, these amounts refer to the total amount of cocoa butter and cocoa butter equivalent in the ingredient. In some instances, the ingredient for a chocolate or chocolate-like product consists of the bloom-retarding additive and the cocoa butter or cocoa butter equivalent and, as such, the cocoa butter or cocoa butter equivalent makes up the balance of the ingredient.

The ingredient for a chocolate or chocolate-like product may be prepared by a method which comprises blending the bloom-retarding additive of the present invention with cocoa butter or a cocoa butter equivalent. Blending may be carried out using conventional methods, e.g. in a mixer.

In some embodiments, the method further comprises preparing the bloom-retarding additive using a method described herein.

### Chocolate and Chocolate-Like Products

Another application of the bloom-retarding additive is in a chocolate or chocolate-like product. The ingredient for a chocolate or chocolate-like product of the present invention may also be used in a chocolate or chocolate-like product.

A chocolate or chocolate-like product of the present invention comprises a bloom-retarding additive or an ingredient for a chocolate or chocolate-like product (which itself comprises the bloom-retarding additive) of the present invention, and one or more further edible ingredients. Preferably, the product is a chocolate product.

Typical edible ingredients that may be used in the chocolate or chocolate-like product include at least one of cocoa solids, sugar and milk powder. For instance, where the product is a dark chocolate, the one or more further ingredients will typically include sugar and cocoa solids but not milk powder. Where the product is a milk chocolate, the one or more further ingredients will typically include sugar, cocoa solids and milk powder. Where the product is a white chocolate, the one or more further ingredients will typically include sugar and milk powder but not cocoa solids.

The chocolate or chocolate-like product may also comprise at least one of cocoa butter or a vegetable fat (i.e. other than cocoa butter) in addition to the bloom-retarding additive or ingredient for a chocolate or chocolate-like product of the present invention. Where the bloom-retarding additive is used in its additive form, i.e. not as part of an ingredient for a chocolate or chocolate-like product, then the chocolate or chocolate-like product will typically comprise at least one of cocoa butter or vegetable fat. Preferably, cocoa butter is used. Suitable vegetable fats include the cocoa butter equivalents listed above in connection with the ingredient for a chocolate or chocolate-like product.

One or more of a wide range of other ingredients and flavourings may also be used in the chocolate or chocolate-like product. A very typical flavouring is vanilla. Other flavourings include coffee, chilli, nuts, fruit (e.g. dried fruit such as raisins, sultanas and cherries), salt, pepper, flavoured oils (e.g. rose, orange and peppermint), caramel, alcohols (e.g. rum) or the like.

The chocolate or chocolate-like product may also comprise additives to enhance its properties, such as an emulsifier. Typical emulsifiers include lecithin (e.g. soy lecithin), though other emulsifiers may also be used.

Advantageously, the bloom-retarding property of the additive of the present invention allows the chocolate or chocolate-like product to be, in its preferred form, otherwise free from bloom-retarding additives, in particular from conventional bloom-retarding additives such as interesterified fats that are not derived from cocoa butter, sorbitan tristearate, or milk fat.

The chocolate or chocolate-like product may comprise the bloom-retarding additive in an amount of at least 1%, preferably at least 3%, and more preferably at least 5% by weight of the product. The chocolate or chocolate-like product may comprise the bloom-retarding additive in an amount of up to 25%, preferably up to 20%, and more preferably up to 15% by weight of the product. Thus, the chocolate or chocolate-like product may comprise the bloom-retarding additive in an amount of from 1 to 25%, preferably from 3 to 20%, and more preferably from 5 to 15% by weight of the product. As mentioned above, the bloom-retarding additive may be included in the chocolate or chocolate-like product as part of an ingredient for a chocolate or chocolate-like product. It will be appreciated that, where more than one bloom-retarding additive of the present invention is used, these amounts refer to the total amount of bloom-retarding additive in the chocolate or chocolate-like product.

The chocolate or chocolate-like product may be prepared by a method which comprises blending a bloom-retarding additive or an ingredient for a chocolate or chocolate-like product of the present invention with the one or more further edible ingredients.

Prior to conching refining takes place, where particles are refined to smaller particles which makes the ingredient less grainy and smoother and finally the refined mass will be conched to improve taste and evaporate water.

The method may further comprise tempering the blended, refined and typically conched, ingredients. Tempering is a well-known process to promote the formation of a target crystalline form, thereby enhancing the stability of the chocolate or chocolate-like product, its glossy appearance and ‘snap’ when broken. Preferably, the chocolate or chocolate-like product is tempered so that the cocoa butter is present in crystalline Form V.

The method may further comprise moulding the chocolate or chocolate-like product, for instance by pouring the tempered chocolate or chocolate-like product into a mould and allowing the product to set.

In some embodiments, the method further comprises preparing bloom-retarding additive using a method as described herein. Additionally or alternatively, the method may comprise preparing the ingredient for a chocolate or chocolate-like product using a method as described herein.

### Properties and Uses

The bloom-retarding additive of the present invention may be used to confer advantageous properties onto ingredients and products in which the additive is used.

For instance, the bloom-retarding additive or ingredient for a chocolate or chocolate-like product of the present invention, which comprises the bloom-retarding components, may be used as a bloom-retarding component in a chocolate or chocolate-like product. Similarly, the bloom-retarding additive of the present invention may be used for enhancing the bloom-retarding properties of cocoa butter or a cocoa-butter equivalent.

In preferred embodiments, the bloom-retarding additive or ingredient prevents the formation of visible fat bloom on a chocolate or chocolate-like product. For instance, visible fat bloom may be prevented for a period of at least 10 weeks, preferably at least 15 weeks, and more preferably at least 20 weeks, when stored at 25° C. Fat bloom is considered visible when a trained expert (panel) considers that it has reached a level of grey at which the product is unacceptable for consumers.

The bloom-retarding additive or the ingredient for a chocolate or chocolate-like product of the present invention may be used for retarding bloom while maintaining the processability of a chocolate or chocolate-like product.

A chocolate or chocolate-like product maintains its processability if, after 10 minutes at a shear rate of 3.4 s⁻¹ and at a temperature relevant for the given product. Thus, different fat compositions will have different outlet temperatures, therefore the outlet temperatures are the relevant temperatures and not a specific. The viscosity of the product has not increased by more than 10% relative to its original viscosity. The viscosity measurements may be carried out on a Brookfield DVIII viscometer using a pre-heated SC 27 spindle and a small sample adapter with a water jacked adjusted to outlet temperature. Shear rate was set to 3.4 s⁻¹.

The following non-limiting examples further illustrate the present invention.

### EXAMPLES

In these examples, the amounts of U₃, SatU₂, Sat₂U and Sat₃, POP, POS and SOS in the different compositions were determined using method AOCS Ce 5b-89 (revised 2017).

In these examples, the amounts of the individual positional isomers, such as SatOSat or SatSatO, were determined by High Performance Liquid Chromatography (HPLC) in combination with an Evaporative Light Scattering Detector (ELSD). The sample preparation consists of an epoxidation of the double bonds of unsaturated fatty acids. This method is known, and suitable methods are available at commercial laboratories, such as Reading Scientific Services Ltd. and Mylnefield Lipid Analysis.

### Example 1: Preparation of Triglyceride Additive Compositions from Cocoa Butter and Oleic Acid

A reaction mixture containing cocoa butter and free fatty acids was prepared and processed according to a method of the present invention to produce triglyceride additive compositions. Pure prime press cocoa butter, i.e. a raw cocoa butter, was used as the cocoa butter, and oleic acid as the fatty acid.

To prepare the reaction mixture, the cocoa butter and free fatty acids were mixed in a reaction vessel. The reaction vessel was equipped with a vacuum inlet, a cold trap and a stirring device. The reaction mixture was then heated to 150° C. over approximately 20 minutes under a reduced pressure of 200 mbar. The temperature was gradually raised to the process temperature and the pressure was gradually lowered to 33 mbar over a period of from 30 to 60 minutes. Once the process temperature was reached, the reaction mixture was left at these conditions for either 11 or 16 hours. The oil that was obtained in the process was then distilled at 240° C. under reduced pressure to remove the excess free fatty acids from the triglyceride additive composition.

The starting materials, reaction conditions, and composition of the triglyceride additive compositions are shown in the following table. For comparison, the composition of pure prime press cocoa butter that has not been subjected to the method of the present invention is also shown.

TABLE 1
Additive compositions I-IV.

| | | Additive composition | | | |
|---|---|---|---|---|---|
| | | I | II | III | IV |
| Starting material | Fatty acid (oleic acid) | 0 | 20.0 | 20.0 | 20.0 |
| (% by weight) | Cocoa butter (pure prime | 100.0 | 80.0 | 80.0 | 80.0 |
| | press) | | | | |
| Reaction conditions | Process temperature (° C.) | — | 210 | 210 | 220 |
| | Process time (hours) | — | 11 | 16 | 11 |
| TAG composition | U₃ | 0.7 | 1.5 | 1.6 | 2.2 |
| | SatU₂ | 7.1 | 18.2 | 20.6 | 24.4 |
| | Sat₂U | 90.5 | 77.6 | 75.2 | 70.3 |
| | Sat₃ | | 2.7 | 2.6 | 3.1 |
| | POP | 15.1 | 13.1 | 12.7 | 11.9 |
| | POS | 38.2 | 32.7 | 31.5 | 29.6 |
| | SOS | 27.2 | 23.4 | 22.5 | 20.9 |
| | SatOSat | 80.5 | 69.2 | 66.7 | 62.4 |
| | SatSatO | <0.5 | 4.7 | 5.4 | 7.0 |
| | Ratio: SatSatO/Sat₃ | <0.5 | 1.74 | 2.07 | 2.26 |

Surprisingly, it can be seen that the triglyceride additive compositions produced by a method of the present invention each have a ratio of SatSatO to Sat₃ which is significantly higher than 1.7. These ratios are not a result of random interesterification. In contrast, the untreated cocoa butter has a ratio of SatSatO to Sat₃ of less than 0.5.

### Example 2: Preparation of Chocolate Bars Containing Triglyceride Additive Compositions Prepared from Cocoa Butter and Oleic Acid

The triglyceride additive compositions prepared in Example 1 were incorporated into a chocolate bar in order to test their bloom-preventing properties.

A basic batch of dark chocolate was prepared from the following ingredients: 52.16% sugar, 42.10% cocoa mass, 5.30% reference cocoa butter I and 0.44% lecithin, by weight. All of the ingredients except lecithin and a part of the fat were blended in a stainless-steel chocolate mélangeur to a plastic consistency which is able to be refined on a 700 mm Lehmann refiner to an average particle size of 20 microns. The refined mass was dry conched for 6 hours in a 50 kg Baurmeister Conch. The remaining part of the fat was added and the mixture conched for a further 6 hours. The lecithin was added 30 minutes before end of conching. The resulting dark chocolate had a fat content of 28.9% by weight.

The dark basic batch of dark chocolate was blended with additive compositions I to IV from Example 1 then formed into chocolate bars. For comparison, an additive composition V which was made by processing the pure prime press cocoa butter using a method as described in WO 2014/071955 A1 was also tested. This additive composition had the following triglyceride composition.

TABLE 2
Additive composition V.

| | | Additive |
|---|---|---|
| | | composition |
| | | V |
| TAG composition | U₃ | 0.7 |
| | SatU₂ | 8.6 |
| | Sat₂U | 87.3 |
| | Sat₃ | 3.4 |
| | SatSatO | 4.7 |
| | Ratio: SatSatO/Sat₃ | 1.38 |

To ensure that any comparisons made between the additive compositions were fair, pure prime press cocoa butter (additive composition I) was also incorporated where necessary to ensure that the same total fat content in all chocolates and the same total SatSatO in chocolate C to F. The chocolate bars were prepared by mixing all ingredients to a homogeneous chocolate on a Teddy mixer with a water jacket at 60° C. for 2 hours.

The composition of the chocolate bars is shown in the following table. For reference, a chocolate bar containing only pure prime press cocoa butter, i.e. additive composition I, was also prepared.

TABLE 3
Chocolates.

| | Chocolate bar | | | | |
|---|---|---|---|---|---|
| | B | C | D | E | F |
| Dark chocolate basic batch | 90 | 90 | 90 | 90 | 90 |
| Additive composition I | 10 | | 1.30 | 3.30 | |
| Additive composition II | | 10 | | | |
| Additive composition III | | | 8.70 | | |
| Additive composition IV | | | | 6.70 | |
| Additive composition V | | | | | 10 |
| Total fat content | 36.0 | 36.0 | 36.0 | 36.0 | 36.0 |
| ΣSat₃ | 1.7 | 2.0 | 1.9 | 2.0 | 2.2 |

It can be seen that the triglyceride additive compositions of the present invention increased the concentration of Sat₃ in the final chocolate product modestly (see Chocolates C-E) as compared an additive prepared according to WO 2014/071955 A1 (see Chocolate F). Thus, the triglyceride additive compositions of the present invention are not expected to significantly enhance the viscosity of a chocolate or chocolate-like product in which they are used.

### Example 3: Bloom-Retarding Performance of Triglyceride Additive Compositions Prepared from Cocoa Butter and Oleic Acid

Experiments were conducted to determine whether the different triglyceride additive compositions had any effect on the shelf-life of the chocolates prepared in Example 2.

Before use, the chocolates prepared in Example 2 were tempered optimally on an AMC 50 tempering machine. 50 g tablet bars were prepared from each chocolate and cooled for 30 minutes in a Morcos 3 zones cooling tunnel. The tablet bars were kept at 20° C.+/−0.5° C. for 1 week after production. The samples were then moved to different cabinets for shelf-life tests at different isothermal temperatures.

The bloom on the different chocolates were assessed by a panel by blind test. Bloom begins as a faint dull and grey layer. Over time, this layer becomes increasingly visible until the chocolate bar is substantially covered in a grey/white layer. The panel decided the level of grey at which the product was unacceptable for consumers. The results of the test are shown in the following table, expressed in terms of the number of weeks from production to unacceptable greyness.

TABLE 4
Bloom assessment of chocolates.

| | | Chocolate | | | | |
|---|---|---|---|---|---|---|
| | | B | C | D | E | F |
| Weeks to unacceptable | 20° C. | >30 | >30 | >30 | >30 | >30 |
| | 23° C. | 10 | >30 | >30 | >30 | >30 |
| | 25° C. | 7 | 24 | 24 | 25 | 25 |

It can be seen that the triglyceride additive compositions of the present invention significantly delayed the onset of visible bloom in a chocolate product (see Chocolates C-E) as compared to cocoa butter (see Chocolate B). The bloom-retarding effect of the triglyceride additive compositions was comparable to that of an additive prepared according to WO 2014/071955 A1 (see Chocolate F).

### Example 4: Viscosity-Altering Performance of Triglyceride Additive Compositions Derived from Cocoa Butter and Oleic Acid

Experiments were conducted to determine whether the different triglyceride additive compositions had any effect on the viscosity of the chocolates prepared in Example 2.

The chocolates prepared in Example 2 were tempered as described in Example 3. Tempered chocolate samples were taken directly from the tempering machine and added to a preheated small sample cup from Brookfield. A preheated SC 27 spindle was used and viscosity measurement taken every 30 seconds for 25 minutes. The water jacket temperature of the small sample adapters was adjusted to be the same as the outlet temperature of tempered chocolate. Shear rate was constant 3.4 s⁻¹. The results of the test are shown in FIG. 1 and in the following table.

TABLE 5
Viscosity of chocolates.

Chocolate

| | B | C | D | E | F |
|---|---|---|---|---|---|
| Minutes to 10% increase in | >25 | 13 | 15 | 12 | 7 |
| viscosity | | | | | |
| Minutes to 20% increase in | >25 | 18 | 23 | 16 | 11 |
| viscosity | | | | | |
| Minutes to 30% increase in | >25 | 24 | 29 | 21 | 15 |
| viscosity | | | | | |

It can be seen that the triglyceride additive compositions of the present invention exhibited a significantly lower detrimental impact on the viscosity of a chocolate product in which the additive is used (see Chocolates C-E), than an additive prepared according to WO 2014/071955 A1 (see Chocolate F).

### Example 5: Preparation of a Triglyceride Additive Composition from Cocoa Butter and a Mixture of Fatty Acids

A further mixture of cocoa butter and fatty acids was prepared and processed using the method described in Example 1. Instead of oleic acid, a mixture of palmitic, stearic and oleic acids was used.

The starting materials, reaction conditions, and the composition of the triglyceride additive composition are shown in the following table.

TABLE 6
Additive composition.

| | | | Additive |
|---|---|---|---|
| | | | composition |
| | | | VI |
| Starting material | Fatty acid | Palmitic acid | 5.0 |
| (% by weight) | | Stearic acid | 8.0 |
| | | Oleic acid | 7.0 |

| | | |
|---|---|---|
| | Cocoa butter (pure prime | 80.0 |
| | press) | |
| Reaction conditions | Process temperature (° C.) | 220 |
| | Process time (hours) | 11 |
| TAG composition | U₃ | 0.8 |
| | SatU₂ | 12.3 |
| | Sat₂U | 81.8 |
| | Sat₃ | 5.1 |
| | POP | 13.6 |
| | POS | 34.1 |
| | SOS | 24.3 |
| | Σ SatOSat | 72.0 |
| | SatSatO | 8.7 |
| | Ratio: SatSatO/Sat₃ | 1.71 |

Once again, by using a method of the present invention, an additive composition comprising a ratio of SatSatO to Sat₃ of greater than 1.7 is obtained. As in Example 1, the ratio cannot be achieved as a result of random interesterification. Surprisingly, this high ratio is still achieved even though the amount of SatOSat at 72% by weight is relatively high (compare to Example 1, II-IV).

1. A bloom-retarding additive comprising a modified cocoa butter which comprises:
SatOSat in an amount of at least 55% by weight,
SatSatO in an amount of at least 1.5% by weight, and
a ratio by weight of SatSatO to Sat₃≥1.5.

2. The bloom-retarding additive of claim 1, wherein the additive further comprises:
U₃ in an amount of at least 0.5% by weight;
SatU₂ in an amount of at least 10% by weight;
Sat₂U in an amount of up to 85% by weight; and
Sat₃ in an amount of at least 2% by weight.

3. A method for preparing a bloom-retarding additive for a chocolate or chocolate-like product, said method comprising:
a) providing a reaction mixture which comprises cocoa butter and free fatty acids, wherein at least some of the free fatty acids are unsaturated; and
b) forming the additive by heating the reaction mixture to a temperature of at least 190° C. and maintaining the temperature for a period of at least 4 hours.

4. The method of claim 3, wherein the cocoa butter used in in step (a) comprises SatOSat in an amount of at least 60% by weight to give an additive having a ratio by weight of SatSatO/Sat₃≥1.5.

5. The method of claim 3, wherein the reaction mixture is heated to a temperature of from 190 to 240° C.

6. The method of claim 3, wherein the temperature is maintained for a period of from 6 to 20 hours.

7. The method of claim 3, wherein the step of forming the additive is carried out under vacuum.

8. The method of claim 3, wherein the reaction mixture comprises the free fatty acids in an amount of from 1 to 35% by combined weight of free fatty acids and cocoa butter.

9. The method of claim 3, wherein:
the free fatty acids are selected from C8 to C22 fatty acids;
and/or the free fatty acids comprise unsaturated fatty acids in an amount of at least 10% by weight of the free fatty acids.

10. The method of claim 3, wherein the method comprises the step of:
c) separating free fatty acids from the additive.

11. The method of claim 3, wherein the reaction mixture consists of free fatty acids and cocoa butter.

12. A bloom-retarding additive which is produced by the method of claim 3.

13. A method of preparing an ingredient for a chocolate or chocolate-like product, said method comprising blending the bloom-retarding additive of claim 1 with cocoa butter and/or a cocoa butter equivalent.

14. An ingredient for a chocolate or chocolate-like product which is produced by the method of claim 13.

15. An ingredient for a chocolate or chocolate-like product which comprises the bloom-retarding additive of claim 1 and cocoa butter and/or a cocoa butter equivalent.

16. The ingredient for a chocolate or chocolate-like product of claim 15, wherein the additive is present in an amount of from 20 to 99% by weight of the ingredient.

17. A method of preparing a chocolate or chocolate-like product, said method comprising blending the bloom-retarding additive of claim 1 with one or more further edible ingredients.

18. A chocolate or chocolate-like product which is obtainable produced by the method of claim 17.

19. A chocolate or chocolate-like product which comprises the bloom-retarding additive of claim 1 and one or more further edible ingredients.

20. The chocolate or chocolate-like product of claim 19, wherein the additive is used in an amount of from 1 to 25% by weight of the product.

21. A method of making a chocolate or chocolate-like product, comprising addition of the ingredient for the chocolate or chocolate-like product of claim 14.

22. A method of making a chocolate or chocolate-like product, comprising addition of or the ingredient for the chocolate or chocolate-like product of claim 14 as a bloom-retarding component in the chocolate or chocolate-like product.

23. A method of making a chocolate or chocolate-like product, comprising addition of the bloom-retarding additive of claim 1 for retarding bloom while maintaining the processability of the chocolate or chocolate-like product.

24. A method of making a cocoa butter or cocoa butter equivalent, comprising addition of the bloom-retarding additive of claim 1.

25. A method of making a cocoa butter or cocoa butter equivalent, comprising addition of the bloom-retarding additive of claim 1 for enhancing the bloom-retarding properties of the cocoa butter or the cocoa butter equivalent.
